(19) United States
(12) Patent Application Publication
(10) Pub. No.: US 2010/0142772 A1
(43) Pub. Date: Jun. 10, 2010

(54) Method and Device for Intelligent Recognition of Microorganisms

(75) Inventors: Yin Lidong, Shenzhen (CN); Lu Changyi, Shenzhen (CN); Sheng Tang, Shenzhen (CN); Yanchuan Liang, Shenzhen (CN)

Correspondence Address: YH CHAN, 42 PIN OAKS DRIVE, PHOENIXVILLE, PA, 19460, US

(73) Assignee: Shenzhen Microprofit Medical Equipment Co.,Ltd., Shenzhen (CN)

(21) Appl. No.: 12/329,642

(22) Filed: Dec. 8, 2008

(51) Int. Cl. G06K 9/00

(52) U.S. Cl. 382/128

(57) ABSTRACT

The present invention discloses a method for intelligent recognition of microorganisms comprising the following steps: a. making a sample; b. microscopic imaging: putting the sample in a photosensitive imaging device, getting an image covering the space of the sample, and importing the image into a central processing unit; c. image processing: implementing preprocessing the image imported into the central processing unit, and getting the sample characteristic; d. recognizing and judging: choosing a microorganism module unit, and comparing the digital information of the unit with the sample characteristic to get the recognition result. The present invention also discloses a device used by the above mentioned method. The method and device provided by the present invention has high rate of detection accuracy, and the function in early diagnosis to reproductive system is very obvious.

### BACKGROUND OF THE INVENTION

The present invention involves medical devices, particularly involves a method and device for intelligent recognition of microorganisms.

Microorganisms have a great effect on human health, and how to recognize a microorganism and control it scientifically is an important subject for the industrial circle. For example, microorganisms represented by Chlamydia trachomatis unit, Urealplasma urealyticum unit, Herpes simplex virus unit, Candida albicans unit, Neisseria gonorrhoeae unit, and Gardnerella vaginalis unit pose a severe challenge to human reproductive health. And reproductive tract infections seriously threaten human health, especially threaten the physical and mental health of women and children. At present, the diagnostic method for reproductive diseases has not high accuracy, and has complicated operations; the time of bacterial culture is long, and the supporting devices are comparatively simplex, which can not implement synthetic judgment to multiple microorganisms.

### BRIEF SUMMARY OF THE INVENTION

The object of the present invention is to solve the problems existing in above mentioned conventional art, to provide a method and device for intelligent recognition of microorganisms.

The technical solution of the present invention is to provide a method for intelligent recognition of microorganisms comprising the following steps:
a. making a sample;
b. microscopic imaging: putting the sample in a photosensitive imaging device, getting an image covering the space of the sample, and importing the image into a central processing unit;
c. image processing: implementing preprocessing the image imported into the central processing unit, and getting the sample characteristic;
d. comparing and judging: choosing a microorganism module unit, and comparing the digital information of the unit with the sample characteristic to get the recognition result.

The present invention also provides a device for intelligent recognition of microorganisms comprising:

a central processing unit with a control software installed;

a microscopic imaging device transforming a sample into digital video signal by photosensitive imaging;

an image processing module implementing preprocessing the image generated by the microscopic imaging device;

a microorganism module composed of multiple microorganism units, and each unit being stored with a kind of descriptive model of microorganism;

a recognition module choosing a microorganism unit to compare it with the digital characteristic of the sample, so as to get the recognition result;

the central processing unit controlling the operation of the microscopic imaging device, the image processing module, the microorganism module, and the recognition module, and outputting the recognition result.

Wherein, the microorganism module comprises Chlamydia trachomatis unit, Urealplasma urealyticum unit, Herpes simplex virus unit, Candida albicans unit, Neisseria gonorrhoeae unit, and Gardnerella vaginalis unit.

Comparing with the conventional art, the present invention has the below said advantages:
1. the detection is quick; the culture time of traditional microorganism microscopic observation is long, and to get a comparatively ideal effect, generally 48 hours are needed, and sometimes even 7-10 days are needed; the detection time of the present invention is about 45 minutes, which comprises the time of making the sample;
2. it has high rate of detection accuracy; it has been proved by clinical trials that the recognition accuracy of the present invention gets to 93%;
3. the operation flow is simple without the need of manual intervention;
4. it has no need of the detection environment;
5. it does not depend on the professional knowledge of the inspector;
6. it can implement remote judgment and discussion via communication network.

### BRIEF DESCRIPTION OF THE DRAWINGS

The present invention is best understood from the following detailed description with reference to the preferred embodiments and accompanying figures, wherein:

FIG. 1 is a structure schematic diagram of the device of the present invention;

FIG. 2 is a flow chart of the method of the present invention;

FIG. 3 is a schematic diagram of the microorganism module of the present invention;

FIG. 4 is a flow chart of the recognition of microorganisms in the present invention; and

FIG. 5 is a flow chart of making a sample to be detected.

### DETAILED DESCRIPTION OF THE INVENTION

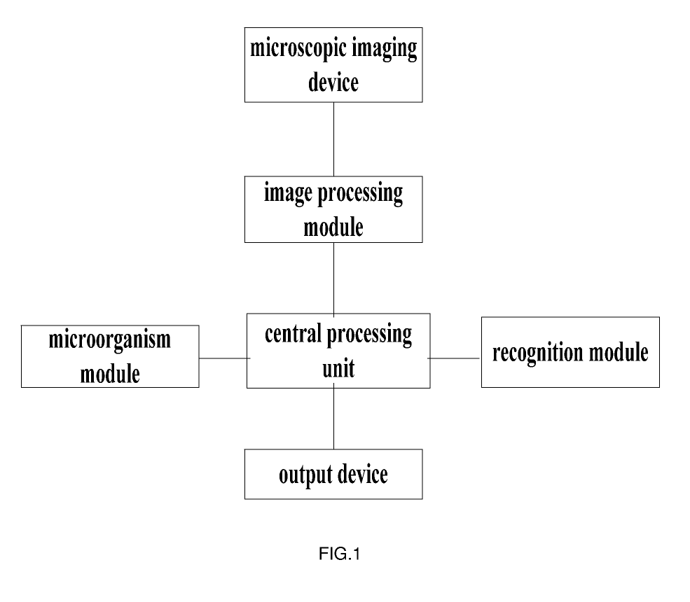

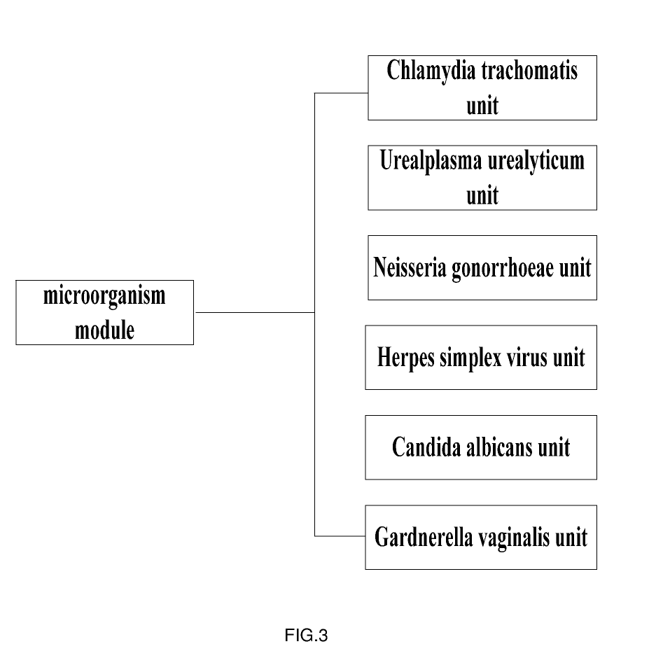

Referring to FIG. 1, the device for intelligent recognition of microorganisms provided by the present invention comprises a central processing unit, a microscopic imaging device, an image processing module, a microorganism module, a recognition module, and a result output device. Wherein, as shown in FIG. 3, the microorganism module is stored with multiple units describing specific microorganism features, such as Chlamydia trachomatis unit, Urealplasma urealyticum unit, Herpes simplex virus unit, Candida albicans unit, Neisseria gonorrhoeae unit, and Gardnerella vaginalis unit.

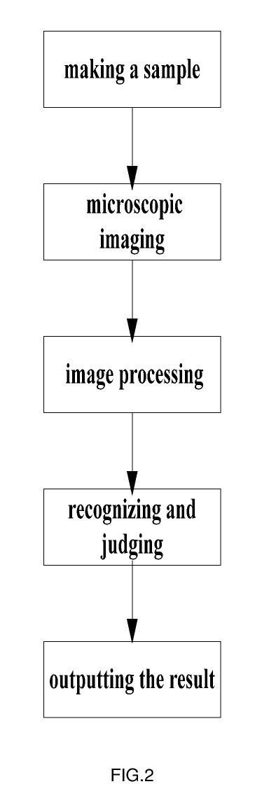

FIG. 2 is a flow chart of the method for intelligent recognition of microorganisms provided by the present invention, which comprises the following steps:

a. making a sample;

b. microscopic imaging: putting the sample in a photosensitive imaging device, getting an image covering the space of the sample, and importing the image into a central processing unit;

c. image processing: implementing preprocessing the image imported into the central processing unit, and getting the sample characteristic;

d. comparing and judging: choosing a microorganism module unit, and comparing the digital information of the unit with the sample characteristic to get the recognition result;

e. outputting the recognition result.

In the step a, the sample to be detected can be made according to the detecting requirements of different microorganisms.

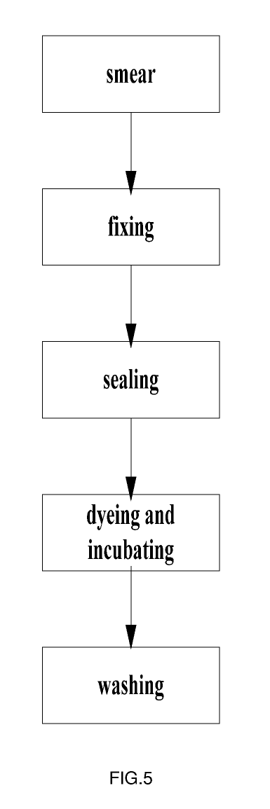

FIG. 5 is the making process of the sample to be detected for Chlamydia trachomatis, which comprises the following steps: smears: holding a terylene cotton swab after sampling with it to uniformly smear the rugged face of a clean sterilized glass slide; fixing: fixing the glass slide into cold methanol; sealing: putting the glass slide into an incubation box, slowly adding 40 ul sealing compound in drops to the covered position of the glass slide, covering with the incubation box cover, keeping the temperature at 37° C., and processing sealing treatment for 10 minutes; dyeing and incubating: opening the incubation box cover, slowly adding 20 ul fluorescent reagent in drops to the position of the glass slide smeared with the sample, covering with the incubation box cover, keeping the temperature at 37° C., and incubating for 30 minutes; washing: making up a washing liquid with the concentrated washing liquid in a immunofluorescence kit and Tween-20 according to the reagent specification, and inserting the incubated glass slide in to the washing liquid to wash for 3 minutes, then, locating the washed glass slide at a aeration drying environment, and waiting it to dry naturally.

After the sample is made, it can be detected via the microscopic imaging device. The microscopic imaging device used in the present invention comprises a fluorescence biological microscope and a digital imaging device.

First, the sample on the glass slide is covered with a cover glass, then a drop of advanced fluoroscope oil is added to the cover glass; the rugged face of the glass slide is placed upwards on the object stage of the microscopic imaging device; the coarse and fine knob of the microscope is tuned to find the luminescent substance with 40× field lens, and then it is replaced with 100× field lens to observe; the fine knob is tuned until a sharp image displays on the display screen of the central processing unit.

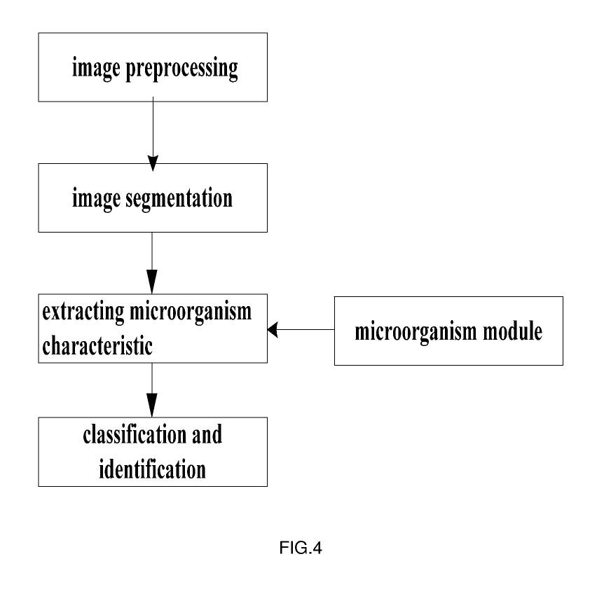

Next, the type of the microorganism to be detected is selected by artificial selection; then, the central processing unit control the image processing module to process the sample to be detected, as shown in FIG. 4, which comprises image preprocessing, image segmentation and extracting sample characteristic. Then, the central processing unit starts the recognition module to compare and recognize the digital information characteristic generated by the image processing module with the selected microorganism type, so as to get the recognition result.

With regard to the same secretion to be detected, multiple samples can be made to be processed and analyzed separately, so as to synthetically judge the test result of the samples, and then the test report is printed out.

The present invention implements fast detection to the patient secretion; after the sample is made, the test result can be gotten in five minutes. The detection process does not need fussy bacterial culture, professional operators, or professional experimental environments; the device of the present invention can be used whatever in a hospital or in a community medical station.

It has been proved by clinical trials that the method and device provided by the present invention has high rate of detection accuracy, and the function in early diagnosis to reproductive system is very obvious.

Further more, the present invention be transmitted via network, so as to implement the remote management of electrical medical record and diagnosis report.

The present invention is not limited to be used in the detection of microorganisms of reproductive system; as long as the microorganism module unit is stored with a certain kind of descriptive model of microorganism feature, that kind of microorganism can be detected.

Although the present invention has been described in detail with above said preferred embodiments, but it is not to limit the scope of the invention. So, all the modifications and changes according to the characteristic and spirit of the present invention, are involved in the protected scope of the invention.

What is claim is:

1. A method for intelligent recognition of microorganisms comprising the following steps:
a. making a sample;
b. microscopic imaging: putting the sample in a photosensitive imaging device, getting an image covering the space of the sample, and importing the image into a central processing unit;
c. image processing: implementing preprocessing the image imported into the central processing unit, and getting the sample characteristic;
d. recognizing and judging: choosing a microorganism module unit, and comparing the digital information of the unit with the sample characteristic to get the recognition result.

2. The method for intelligent recognition of microorganisms of claim 1, wherein the microorganism module comprises Chlamydia trachomatis unit, Urealplasma urealyticum unit, Herpes simplex virus unit, Candida albicans unit, Neisseria gonorrhoeae unit, and Gardnerella vaginalis unit.

3. The method for intelligent recognition of microorganisms of claim 1, wherein it also comprises step e: storing, printing, or transmitting the recognition result.

4. The method for intelligent recognition of microorganisms of claim 1, wherein the sample said in step a is a glass slide coated with a microorganism to be detected.

5. A device for intelligent recognition of microorganisms comprising:
a central processing unit with a control software installed;
a microscopic imaging device transforming a sample into digital video signal by photosensitive imaging;
an image processing module implementing preprocessing the image generated by the microscopic imaging device;
a microorganism module composed of multiple microorganism units, and each unit being stored with a kind of descriptive model of microorganism;
a recognition module choosing a microorganism unit to compare it with the digital characteristic of the sample, so as to get the recognition result;
the central processing unit controlling the operation of the microscopic imaging device, the image processing module, the microorganism module,
and the recognition module, and outputting the recognition result.

6. The device for intelligent recognition of microorganisms of claim 5, wherein the microorganism module comprises Chlamydia trachomatis unit, Urealplasma urealyticum unit, Herpes simplex virus unit, Candida albicans unit, Neisseria gonorrhoeae unit, and Gardnerella vaginalis unit.

7. The device for intelligent recognition of microorganisms of claim 5, wherein the microscopic imaging device comprises a fluorescence biological microscope and a digital imaging device.

8. The device for intelligent recognition of microorganisms of claim 5, wherein it also comprises devices for printing, storing, and network transmission, which are connected to the central processing unit.

9. The device for intelligent recognition of microorganisms of claim 5, wherein the sample is a glass slide coated with a microorganism to be detected.
